(19) United States
(12) Patent Application Publication
(10) Pub. No.: US 2026/0105874 A1
(43) Pub. Date: Apr. 16, 2026

(54) DISPLAY WITH CONTROLLABLE CIRCADIAN STIMULATION

(71) Applicant: KORRUS, INC., Los Angeles, CA (US)

(72) Inventor: Benjamin HARRISON, Los Angeles, CA (US)

(21) Appl. No.: 19/418,538

(22) Filed: Dec. 12, 2025

Related U.S. Application Data
(63) Continuation of application No. PCT/US24/37084, filed on Jul. 8, 2024.
(60) Provisional application No. 63/525,471, filed on Jul. 7, 2023.

(51) Int. Cl. G09G 3/20; G09G 3/32; G09G 3/3208

(52) U.S. Cl. CPC G09G 3/2003; G09G 3/32; G09G 3/3208; G09G 2300/0452; G09G 2320/0242; G09G 2320/0666

(57) ABSTRACT

A display comprising: (a) an array of pixels, each pixel comprising at least four subpixels, said at least four subpixels comprising a red subpixel (R), a green subpixel (G), a cyan subpixel (C), and a violet subpixel (V); and (b) a controller for controlling said subpixels in two or more modes, a first mode having a first gamut in which said R, G, and V are driven, and a second mode having a second gamut, said second gamut having two sub-gamuts, a first sub-gamut in which said R, C and G are driven, and a second sub-gamut in which said R, C, and V are driven.

### REFERENCE TO RELATED APPLICATION

The present disclosure claims the benefit of U.S. Provisional Patent Application 63/525,471, filed Jul. 7, 2023, the entire disclosure of which is hereby incorporated by reference.

### FIELD OF INVENTION

The present disclosure relates generally to a display, and, more particularly, to a display having controllable circadian stimulation and a broad gamut.

### BACKGROUND

In a conventional OLED display, there are three emitters or subpixels per pixel—i.e., red (at 620nm), green (at 520nm), and blue (at 460nm). While such a configuration provides for an adequate gamut, Applicant recognizes that it provides very little flexibility in controlling circadian stimulation. As used herein, the term “circadian-stimulating energy characteristics” refers to any characteristics of a spectral power distribution that may have biological effects on a subject. Circadian-stimulating energy characteristics may be described in various terms, including, for example, circadian-stimulating energy (CSE), circadian stimulation (CS), Equivalent Melanopic Lux (EML), and M/P ratio, and “blue per lumen.” Of particular interest herein are EML and M/P ratio. EML provides a measure of photoreceptive input to circadian and neurophysiological light responses in humans. The M/P ratio compares the melanopic (ipRGC) potential to the light source's ability to produce light for daytime detail vision (photopic vision).

Applicant recognizes a need for a display having more control to moderate circadian stimulation while maintaining a wide color gamut. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Applicant recognizes that eliminating the blue emitter and substituting instead a violet or a violet and a cyan emitter provides a display with a broad gamut and variable circadian stimulation.

One aspect of the invention is a display having a wide gamut in a variable circadian stimulation. In one environment, the display comprises (a) an array of pixels, each pixel comprising at least four subpixels, the at least four subpixels comprising a red subpixel (R), a green subpixel (G), a cyan subpixel (C), and a violet subpixel (V), and (b) a controller for controlling the subpixels in two or more modes, a first mode having a first gamut in which the R, G, and V are driven, and a second mode having a second gamut, the second gamut having two sub-gamuts, a first sub-gamut in which the R, C and G are driven, and a second sub-gamut in which the R, C, and V are driven.

Another aspect of the invention is a display having a wide gamut and low circadian stimulation (CS). In one embodiment, the low CS display comprises (a) an array of pixels, each pixel comprising at least three subpixels, the at least three subpixels comprising a red subpixel (R), a green subpixel (G), and a violet subpixel (V); wherein the R has a peak wavelength of 600-640nm, the G has a peak wavelength of 520-560nm, and the V has a peak wavelength of 400-440nm; and (b) a controller for driving the subpixels.

### BRIEF DESCRIPTION OF FIGURES

FIG. 1 shows the spectral power distribution (SPD) of one embodiment of the violet, cyan, green and red subpixels.

FIG. 2 shows that the DCI-P3 gamut lies within the available gamut provided by the embodiment of the subpixels of FIG. 1.

FIG. 3 shows that the DCI-P3 gamut lies within the available sub-gamuts provided in the day mode of one embodiment of the invention.

FIG. 4 shows that the DCI-P3 gamut lies within the available sub-gamut provided in the night mode of one embodiment of the invention.

FIGS. 5A-C show metamers of different colors using the subpixel embodiment shown in FIG. 1.

FIG. 6 shows a schematic of one embodiment of the display.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In one embodiment, the present invention relates to a display comprising: (a) an array of pixels, each pixel comprising at least four subpixels, the at least four subpixels comprising a red subpixel (R), a green subpixel (G), a cyan subpixel (C), and a violet subpixel (V); and (b) a controller for controlling the subpixels in two or more modes, a first mode having a first gamut in which the R, G, and V are driven, and a second mode having a second gamut, the second gamut having two sub-gamuts, a first sub-gamut in which the R, C and G are driven, and a second sub-gamut in which the R, C, and V are driven.

It is worth noting that in this embodiment, the array of pixels does not have a blue subpixel.

In one embodiment, the subpixels are emissive. For example, the subpixels may be OLEDs or microLEDs.

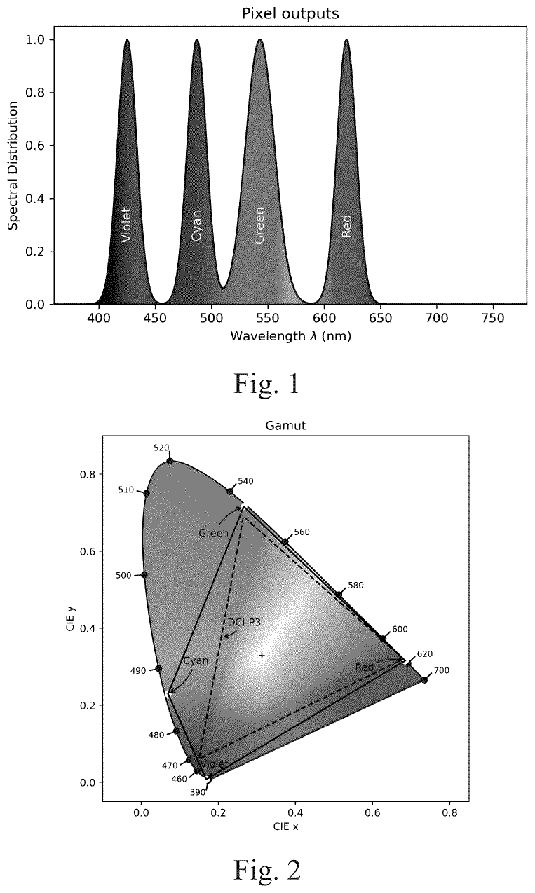

Referring to FIG. 1, the spectral power distribution (SPD) of one embodiment of the violet, cyan, green and red subpixels is shown. As shown, the R has a peak wavelength of 600-640 nm, the G has a peak wavelength of 520-560 nm, the C has a peak wavelength of 470-510 nm, and the V has a peak wavelength of 400-440 nm. More particularly, the R has a peak wavelength of 610-630 nm, the G has a peak wavelength of 530-550 nm, the C has a peak wavelength of480-500 nm, and the V has a peak wavelength of 410-430 nm. In a more particular embodiment, the R has a peak wavelength of 620 nm, the G has a peak wavelength of 543 nm, the C has a peak wavelength of 487 nm, and the V has a peak wavelength of 425 nm.

As can be seen in FIG. 2, the full gamut area of DCI-P3 is contained within the gamut provided by the subpixels of this embodiment.

In one embodiment, the subpixels are driven in at least two main modes, a first mode or night mode and second mode or day mode. It is possible to exist in a blended state. This may be used during dawn and dusk as a transition.

In the night mode, the impact of the display can be minimized by minimizing the use of the cyan channel. In one embodiment, this is achieved by dividing the gamut into two zones or sub gamuts. As shown in FIG. 4, zone 1 or the RGV sub gamut substantially overlaps the target gamut, so good performance could be achieved using only zone 1. Optionally, the cyan channel may be used to expand the display gamut during night mode operation by using the sub-gamut GCV which is shown as zone 2 in FIG. 4. It should be noted that use of zone 2 increases the blue content of images containing colors in this region.

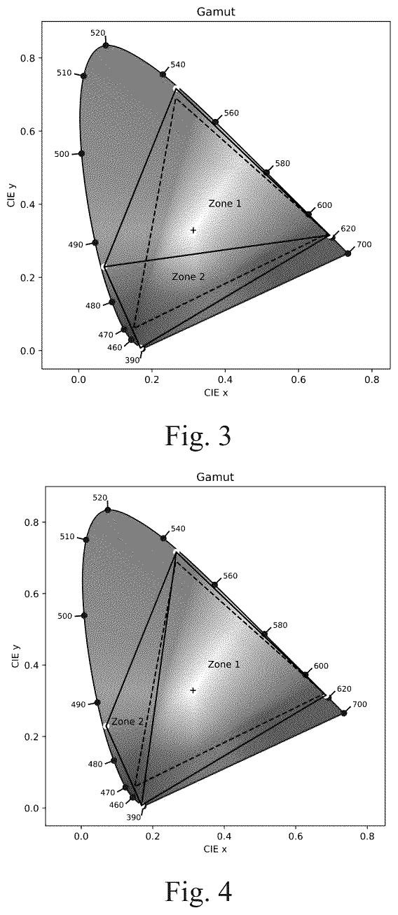

To maximize the daytime impact in the day mode, the display should maximize the use of the cyan channel. In one embodiment, this can be achieved by dividing the gamut into two portions or two sub-gamuts produced by RGC and RCV, which are shown as zones 1 and 2 respectively in FIG. 3. The display gamut (e.g., DCI-P3) overlaps both sub-gamuts as shown in FIG. 3. During decoding, in one embodiment, the display driver integrated circuit (DDIC) (described below) selects which sub-gamut to use on a per pixel basis.

In one embodiment, the day and night modes are controlled by a circadian signal. For example, in one embodiment, the circadian signal is encoded on a single dimension with a finite range, for example from 0 to 1, with 0 being fully night mode and 1 being fully day mode, and any value between 0 and 1 corresponding to a proportional mix of the night and day modes. The circadian signal can be made to follow local clock time/date, thereby replicating the sun, or it can be tailored to the specific needs of the display user.

In one embodiment, the night and day modes have common colors, wherein each common color has a first spectral power distribution (SPD) in the night mode, and a second SPD in the day mode. In one embodiment, the first SPD has a lower m/p ratio than the second SPD. In one embodiment, the m/p ratio of the first SPD is less than half that of the second SPD.

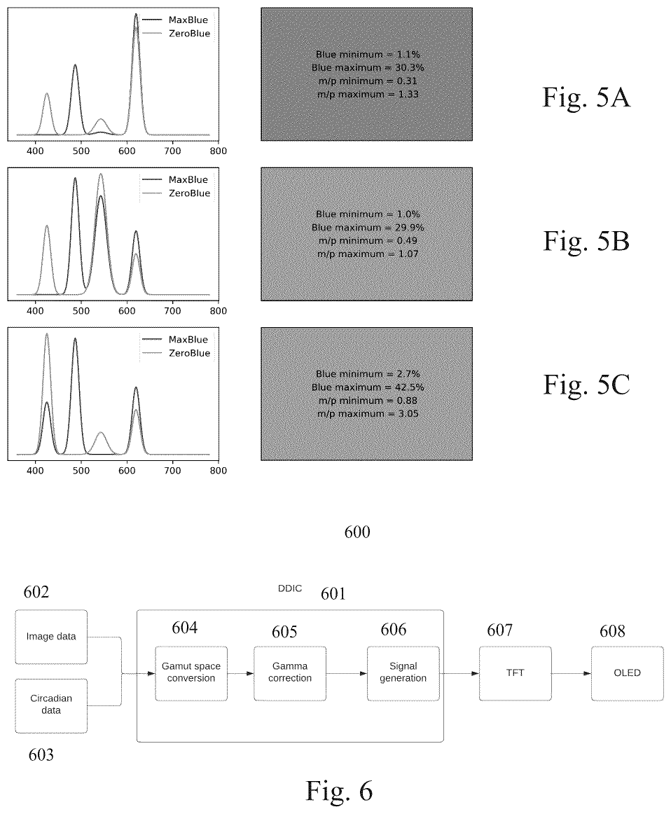

In one embodiment, the first and second SPDs comprise a metameric pair. For example, referring to FIGS. 5A-C, metameric pairs for different colors are shown. Specifically. FIG. 5A shows a metameric pair for red, FIG. 5B shows a metameric pair for green, and FIG. 5C shows a metameric pair for purple. In these figures, the SPD labeled ZeroBlue is the SPD in the night mode, and the SPD labeled MaxBlue is the SPD in the day mode. As can be seen in these figures, a common light color can be achieved by powering the subpixels differently. For example, in the common red color of FIG. 5A, in the night mode, the violet and green subpixels are powered while the cyan subpixel is not. Conversely, in the day mode, the violet and green subpixels are not powered and the cyan subpixel is. The red subpixel is powered in both modes. The result of powering different subpixels differently results in substantially different circadian effects. Specifically, in the example of FIG. 5A, the m/p ratio for the night mode is 0.31 while the m/p ratio for the day mode is 1.33. In each example, the m/p ratio of the night mode color is less than half that of the day mode color, yet the perceived color is the same.

Referring to FIG. 6, a schematic of one embodiment of the display 600 of the present invention is shown. In this embodiment, the controller comprises a display driver integrated circuit (DDIC) 601 configured to receive a circadian data signal 603 to select one of the two or more modes. In one embodiment, the DDIC is configured to receive an image data signal 602 and a circadian data signal 603. A gamut space conversion module 604 then selects one of the two or more modes or combinations thereof based on the circadian data signal. A signal generation module 606 then generates a display signal in the selected mode based on the image data signal. A gamma correction module 604 may also be used to perform gamma correction as is well known in the art. The display signal from the DDIC 601 is received in a thin filter transistor (TFT) 607 in one embodiment. The TFT controls the current that drives each subpixel—e.g., OLED 608.

In another embodiment, the display is configured just for low CS. In one embodiment, the low CS display comprises (a) an array of pixels, each pixel comprising at least three subpixels, the at least three subpixels comprising a red subpixel (R), a green subpixel (G), and a violet subpixel (V); wherein the R has a peak wavelength of 600-640 nm, the G has a peak wavelength of 500-560 nm, and the V has a peak wavelength of 400-440 nm; and (b) a controller for driving the subpixels In one embodiment, the R has a peak wavelength of 610-630 nm, the G has a peak wavelength of 530-550 nm, and the V has a peak wavelength of 410-430 nm. In a more particular embodiment, the R has a peak wavelength of 620 nm, the G has a peak wavelength of 543 nm, and the V has a peak wavelength of 425 nm.

These and other advantages maybe realized in accordance with the specific embodiments described as Well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A display comprising:
an array of pixels, each pixel comprising at least four subpixels, said at least four subpixels comprising a red subpixel (R), a green subpixel (G), a cyan subpixel (C), and a violet subpixel (V); and
a controller for controlling said subpixels in two or more modes, a first mode having a first gamut in which said R, G, and V are driven, and a second mode having a second gamut, said second gamut having two sub-gamuts, a first sub-gamut in which said R, C and G are driven, and a second sub-gamut in which said R, C, and V are driven.

2. The display of claim 1, wherein said array of pixels does not have a blue subpixel.

3. The display of claim 1, wherein said subpixels are emissive.

4. The display of claim 3, wherein said subpixels are OLEDs.

5. The display of claim 3, wherein said subpixels are microLEDs.

6. The display of claim 1, wherein said R has a peak wavelength of 610-630 nm, said G has a peak wavelength of 530-550 nm, said C has a peak wavelength of480-500 nm, and said V has a peak wavelength of 410-430 nm.

7. The display of claim 1, wherein said R has a peak wavelength of 620 nm, said G has a peak wavelength of 543 nm, said C has a peak wavelength of 487 nm, and said V has a peak wavelength of 425 nm.

8. The display of claim 1, wherein said first and second gamuts have common colors, wherein each common color has a first spectral power distribution (SPD) in said first gamut, and a second SPD in said second gamut, wherein said first and second SPDs are different, and wherein said first SPD has a lower m/p ratio than said second SPD.

9. The display of claim 8, wherein said first and second SPDs comprise a metameric pair.

10. The display of claim 1, wherein said controller is configured for controlling said subpixels in a third mode, said third mode being a combination of said first and second gamuts.

11. The display of claim 10, wherein said third mode comprises said first gamut and a third gamut in which said G, C, and V are driven.

12. The display of claim 1, wherein said controller comprises a display driver integrated circuit (DDIC) configured to receive a circadian data signal to select one of said two or more modes.

13. The display of claim 12, wherein said DDIC is configured to:
receive an image data signal and a circadian data signal;
select one of said two or more modes based on said circadian data signal; and
generate a display signal in a selected mode based on said image data signal.

14. The display of claim 12, wherein said DDIC is configured to select said first or second sub-gamuts on a per pixel basis.

15. The display of claim 12, wherein said circadian data signal ranges from 0 to 1, with 0 being full said first mode, 1 being full said second mode, and between 0 and 1 being a combination of said first and second modes.

16. The display of claim 15, wherein said between said 0 and 1 is a third mode.

17. The display of claim 12, wherein said circadian data signal is based on sun movement.

18. (canceled)

19. (canceled)

20. (canceled)
